(19) United States
(12) Patent Application Publication
(10) Pub. No.: US 2007/0255947 A1
(43) Pub. Date: Nov. 1, 2007

(54) Methods and systems for incremental crypto processing of fragmented packets

(76) Inventors: Abhijit K. Choudhury, Cupertino, CA (US); Himanshu Shukla, Sunnyvale, CA (US); Adrian Lewis, Cupertino, CA (US); Shekhar Ambe, San Jose, CA (US); Sodhanshu Jain, Fremont, CA (US); Mohanakumari B. T., Bangalore (IN); Mathew Kayalackakom, Cupertino, CA (US)

Correspondence Address: PILLSBURY WINTHROP SHAW PITTMAN LLP, P.O. BOX 10500, MCLEAN, VA, 22102, US

(21) Appl. No.: 11/351,331

(22) Filed: Feb. 8, 2006

Related U.S. Application Data
(60) Provisional application No. 60/651,596, filed on Feb. 9, 2005.

(51) Int. Cl. H04L 9/00

(52) U.S. Cl. 713/161

(57) ABSTRACT

Methods and systems for providing confidentiality and/or integrity to fragmented packet transmissions, without reassembly of the fragments, across wired and wireless communications networks are disclosed. Encryption of a first fragmented packet can be performed by using an initial encryption state variable and keying material resulting in a first ciphertext fragment and a first encryption state variable. Then encryption of a second fragments packet can be performed by using the first encryption state variable and the keying material resulting in a second ciphertext fragment. Decryption of fragments can be performed in a similar manner as encryption. Computation of a message authentication code can be performed by computing a first hash state value for a first block size of bytes of a first packet fragment using an initial hash state value, and storing the first hash value and a first set of remainder bytes of the first packet fragment. The computation of the MAC continues by combining the first set of remainder bytes to a second packet fragment of the plurality of packet fragments resulting in a combined packet fragment. The MAC can then be identified using the second hash state value.

### CROSS-REFERENCE TO RELATED APPLICATIONS

This application claims the benefit of priority from U.S. Provisional Patent Application Ser. No. 60/651,596, filed Feb. 9, 2005, entitled “Incremental Crypto Processing of Fragmented Packets”, and which is fully incorporated herein by reference for all purposes.

### BACKGROUND OF THE INVENTION

1. Field of the Invention

Generally, the present invention relates to packet transmissions over communications networks. More specifically, the present invention relates to providing confidentiality and/or integrity to fragmented packet transmissions across wired and wireless communications networks.

2. Description of the Related Art

Wired and wireless networks are well known in the art today. As used herein, the term network is meant to include all wired or wireless networks, and any combination thereof. Equally well known in the art are problems associated with providing confidentiality and/or integrity to communications between users over these networks. To provide confidentiality and/or integrity to a user's network traffic, various encryption and authentication algorithms are typically used. For example, WEP (wired equivalent privacy), TKIP (temporal key integrity protocol) and AES-CCMP (advanced encryption standard—counter-mode cipher-block chaining-message authentication code protocol) are used for securing wireless network traffic, while IPSec (Internet Protocol Security) is the primary mechanism used for encrypting and authenticating wired network traffic.

Typical network traffic is broken up and transmitted over a network in packets. Depending on the equipment used within the network and the transmission medium and protocol/standard of the network itself, packets can be fragmented during transmission. Data may be fragmented for various reasons. If the packet length exceeds the maximum transmission unit (MTU), the packet may be fragmented. Also, fragmentation may be required because, under certain circumstances, it may be more efficient to send smaller units of data. The same holds true for security traffic. This confidential data may be fragmented because the security mechanism used may increase the original data size and cause it to exceed the MTU.

Thus, the security information can often straddle across fragments. Handling confidentiality and/or integrity for such fragments in software and/or hardware is a difficult and time consuming task at best.

In the typical case, where software attempts to handle fragmented packets, if the packet also needs to be secured, it is encrypted and authenticated by software modules. The security modules also decrypt and validate received fragmented packet data. The software modules handle confidentiality information on a per complete packet basis. In cases where the confidentiality information is split across fragments, these fragments are first reassembled, and the reassembled packet is then fed to the security modules. However, in this case, decryption cannot be performed until all of the fragments have been reassembled, and encryption and decryption are very CPU intensive tasks when performed by software modules. Hence the software solutions are inherently very slow.

In the typical case, where hardware attempts to handle fragmented packets; a specialized hardware processor is used to encrypt and decrypt the data. The hardware security coprocessor works in conjunction with software. Once the software determines that there is a need for confidentiality processing, the software hands over the packet to the hardware. The hardware coprocessor can then perform the encryption, and will compute the authentication data, known as the MAC (message authentication code), for the packet. The hardware can then hand the packet back to the software, where the software fragments the data. Similarly, for packets needing decryption and packet validation, the software hands over the reassembled fragments to the hardware coprocessor. The hardware can then decrypt and validate the MAC for these packet.

However, in this case, decryption and packet validation cannot be performed until all of the fragments have been reassembled. Because of this required reassembly, there is an overhead incurred in terms of latency and fragment storage. Also, most of the hardware based solutions have a limit on the maximum length of packets which they can handle. In cases where the packet length exceeds the packet maximum length, the packet needs to be secured in software.

Therefore, what is needed is a mechanism for handling confidentiality information that straddles across packet fragments in a fast and efficient manner, regardless of the packet length and without the need for fragment reassembly.

### BRIEF DESCRIPTION OF THE DRAWINGS

Aspects and features of the present invention will become apparent to those ordinarily skilled in the art from the following detailed description of certain embodiments of the invention in conjunction with the accompanying drawings, wherein:

FIG. 1 illustrates exemplary encryption and decryption schemes for a stream of plaintext data, one byte at a time, used in accordance with certain embodiments of the present invention;

FIG. 2 illustrates exemplary encryption and decryption schemes for blocks of plaintext data used in accordance with certain embodiments of the present invention;

FIG. 3 illustrates exemplary incremental encryption and decryption schemes for fragments used in accordance with certain embodiments of the present invention;

FIG. 4 illustrates an exemplary one-way hash function used in accordance with certain embodiments of the present invention; and

FIG. 5 illustrates an exemplary incremental MAC computation for fragments used in accordance with certain embodiments of the present invention.

### DETAILED DESCRIPTION OF THE INVENTION

The present invention will now be described in detail with reference to the drawings, which are provided as illustrative examples of the invention so as to enable those skilled in the art to practice the invention and are not meant to limit the scope of the present invention.

Certain embodiments of the present invention include a mechanism for efficiently handling confidentiality and/or integrity information that straddles across fragments. The methods of certain embodiments of the invention can be implemented in software, in hardware, or in a combination of software and hardware. With certain embodiments of the present invention, there is no need to reassemble packets before proceeding with computation of security information. Further, certain embodiments of the present invention can be used to secure large packets. Additionally, certain embodiments of the present invention can provide security at wire speed for fragmented traffic.

Encryption algorithms can take the raw data, or plaintext, and convert it into encrypted data, or ciphertext. As a general rule, symmetric algorithms can be used for encrypting network data. For example, symmetric algorithms maintain a notion of a state S. The state S can be represented by a set of fixed information. Given the encryption algorithm, keying material and the state variable S, a certain piece of plaintext P will always be encrypted into cipher text C. The encryption algorithm can operate either on streams of plaintext, i.e., one byte at a time, or on blocks of plaintext, which can include one to many bytes of data.

In certain embodiments, an encryption algorithm can operate on streams of plaintext data one byte at a time, where the state variable changes for each byte of data that is encrypted. Consider the following byte-by-byte encryption example. Given the encryption algorithm E, the state S, and the keying material K, a plaintext byte b1 would be encrypted into ciphertext c1, and the state variable would change from S to S1. This same algorithmic rule holds true for each subsequent byte as well. Thus, if n bytes of plaintext data, b1 . . . bn, have already been encrypted and the state variable has likewise changed from S→Sn, then using Sn, the encryption algorithm E, the keying material K, the next byte of plaintext data, i.e., the (n+1) byte, can be encrypted. As these are symmetric algorithms, a corollary algorithmic rule holds true for decryption also. If one starts from an initial state D, using this state variable, the algorithm specified for decryption and the keying material, decryption of the first n ciphertext bytes, c1 . . . cn, would result in plaintext bytes b1 . . . bn and a state change from D→Dn, where Dn can then be used to decrypt the next ciphertext byte, i.e., the (n+1) byte.

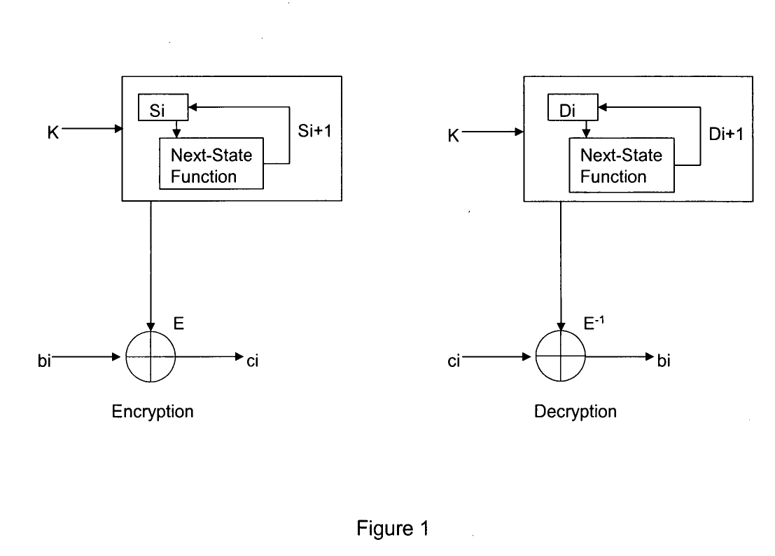

FIG. 1 illustrates exemplary encryption and decryption schemes for a stream of plaintext data, one byte at a time, used in accordance with certain embodiments of the present invention. As shown in FIG. 1, bytes of plaintext bi are encrypted into ciphertext ci using encryption algorithm E and keying material K, given the state variable Si. As previously discussed, once bi is encrypted, the state variable will be changed to S(i+1) using the next-state function feedback loop, where the function depends on the specific encryption algorithm used. Decryption can follow a similar mechanism. Ciphertext ci is decrypted into plaintext bi using decryption algorithm E⁻¹ and keying material K, given the state variable Di. As illustrated, decryption algorithm E⁻¹ is complementary to encryption algorithm E (and vice versa). As previously discussed, once ci is decrypted, the state variable will be changed to D(i+1) using the next-state function feedback loop.

In certain embodiments, using the above principles, data across fragmented packets can be encrypted and decrypted. For example, assume that packet P is fragmented into n fragments F1 . . . Fn. F1 can be encrypted as described above; that is, the initial state S, the keying material K and the encryption algorithm E can be used to encrypt F1. After the encryption of F1 is complete, the state changes from S→Si. Then, for encrypting F2, rather than using S as the initial state, S1 is used as the initial state and the fragment is encrypted. In general, if fragment Fi needs to be encrypted, then state S(i−1) can be used as the initial state for encryption. In this way, data across multiple fragments can be encrypted. At the time of decryption, a similar process can be followed, where the first fragment is decrypted as previously described; but for subsequent fragments, rather than starting from an initial state D, the state variable D(i−1) is used as the initial state for decrypting the i-th fragment.

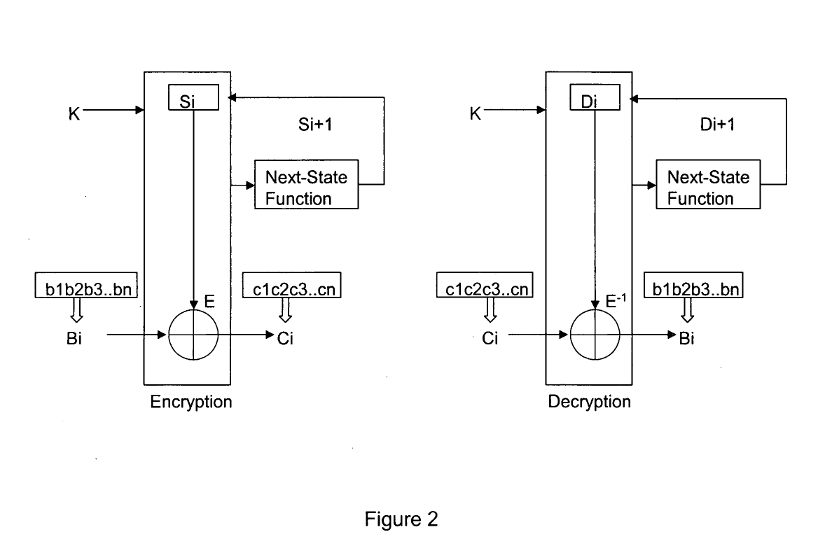

In certain embodiments, an encryption algorithm can operate on blocks of data, i.e., one or more bytes grouped together for communications purposes on the network, where the state variable changes after encrypting the block of data, instead of after each byte. This changed state variable can then be used for encrypting the next block of data. FIG. 2 illustrates exemplary encryption and decryption schemes for blocks of plaintext data used in accordance with certain embodiments of the present invention. As shown in FIG. 2, blocks of plaintext Bi (i.e., Bi can include n bytes of plaintext, b1b2b3 . . . bn, for n>=1) are encrypted into ciphertext Ci (i.e., Ci can include n bytes of ciphertext, c1c2c3 . . . cn, for n>=1) using encryption algorithm E and keying material K, given the state variable Si. As previously discussed, once Bi is encrypted, the state variable will be changed to S(i+1) using the next-state function feedback loop. If the last block is not a multiple of the block size, then padding bytes (e.g., normally zeros, depending on the scheme) can be added to make it a multiple of the block size. Decryption can follow a similar mechanism. Ciphertext Ci is decrypted into plaintext Bi using decryption algorithm E⁻¹ and keying material K, given the state variable Di. As previously discussed, once Ci is decrypted, the state variable will be changed to D(i+1) using the next-state function feedback loop.

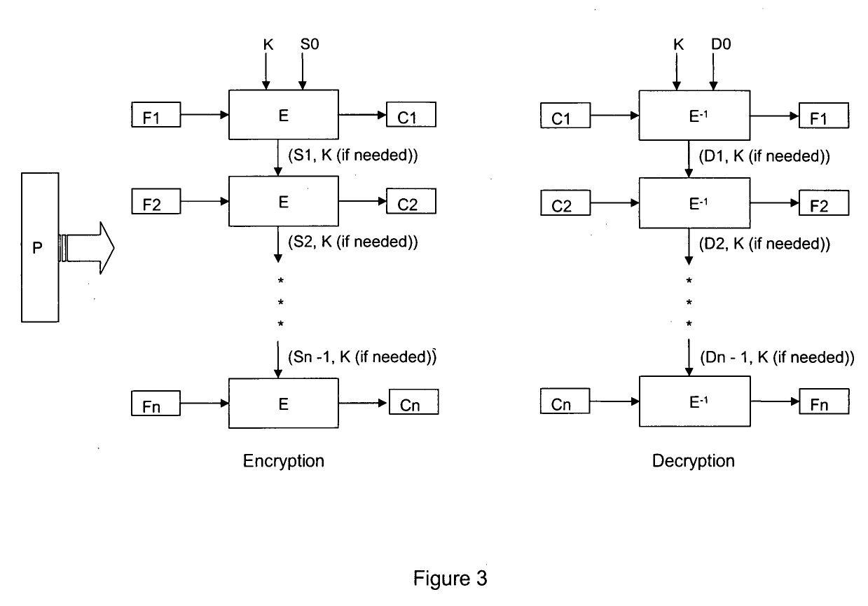

For such block encryption algorithms, if the packet are fragmented in such a way that, for each of the non-last fragments, the data needing encryption is a multiple of block size, then this block algorithm can be used. FIG. 3 illustrates exemplary incremental encryption and decryption schemes for fragments used in accordance with certain embodiments of the present invention. As shown in FIG. 3, assume that an encryption algorithm E, which encrypts data in blocks sizes of b, is being used to encrypt a packet P. Let the packet P get fragmented into n fragments, F1 . . . Fn, such that the data needing encryption for each of the fragments F1 . . . F(n−1) is a multiple of block size b. In such circumstances, after encrypting F1 into ciphertext C1, the initial state variable S changes to S1. This state variable S1, along with K as needed, can passed and used to incrementally encrypt the second fragment, F2. In general after fragment Fi (for i <n) is encrypted into ciphertext Ci, the state variable changes from S(i−1) to Si and Si can then be used as the initial state for incrementally encrypting the fragment F(i+1). If the last fragment is not a multiple of the block size, then padding bytes (e.g., normally zeros, depending on the scheme) can be added to make it a multiple of the block size. Decryption for fragments within blocks follows this same methodology.

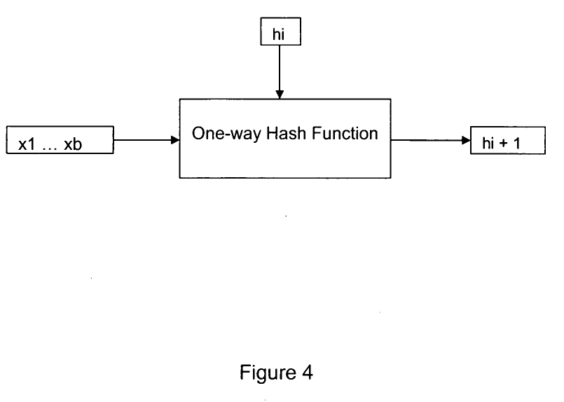

In certain embodiments, for an authentication algorithm to compute a message authentication code (MAC), one-way hash functions can be used. FIG. 4 illustrates an exemplary one-way hash function used in accordance with certain embodiments of the present invention. As shown in FIG. 4, data in blocks of size b (x1 . . . xb) can be used as the input to the one-way hash function. A previous hash function value hi, which might be the result from a previous one-way hash function, can be used with the present one-way hash function. The resultant hash value h(i+1) can then be used as the MAC, or as an input to the next incremental one-way hash function.

Certain embodiments of the invention are applicable where the computed MAC is appended to the end of the packet. As in a symmetric encryption/decryption algorithm, MAC computation can be accomplished incrementally and also has a notion of state S. The authentication algorithm can expect data in blocks of size b, or on a byte by byte basis. Hash functions that calculate MAC on a per byte basis can be treated as a special case of the block algorithm, where the block size of equal to one.

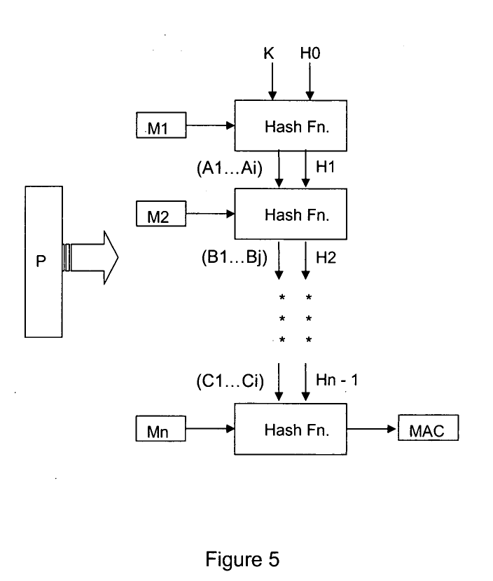

FIG. 5 illustrates an exemplary incremental MAC computation for fragments used in accordance with certain embodiments of the present invention. If the authentication algorithm expects data in blocks of size x and the initial hash function state is H0, then the hash function state would change to H1 after authenticating a block of b bytes. This changed state H1 can then be used to incrementally compute the authentication data for the next block of b bytes. So, if a packet P gets fragmented into, for example, two fragments M1 and M2, such that M1=x×b+y bytes and M2=z bytes (where y and z are constants for left-over bytes, either of which can be zero), then for fragment M1, the MAC is calculated for x×b bytes (i.e., for x blocks, each of size b). The intermediate state H1 and remaining y bytes are temporarily stored. The next fragment M2 is appended to the stored y bytes and the MAC is calculated over y+z bytes with initial state H1. The computed MAC is placed at the end of the fragment M2. More generally, a MAC can be computed using incremental one-way hash functions for n fragments M1 . . . Mn of packet P. Each incremental one-way hash function can expect to process blocks of data of size b, using its incremental hash function state, while outputting the next incremental hash function state and any remainder bytes from the just-processed fragment. If the last fragment is not a multiple of the block size (i.e., has left-over bytes), then padding bytes (e.g., normally zeros, depending on the scheme) can be added to make it a multiple of the block size. For packet validation, the MAC can then be computed again, as mentioned above, and compared with MAC in the fragments. Note that in certain circumstances, calculating the MAC might require keying material.

Certain embodiments of the present invention are applicable to a variety of confidentiality mechanisms used in today. Each of these confidentiality mechanisms has a way of securing packets. It should be noted that all the nuances specified by each security mechanism should be considered when using aspects of the present invention with such schemes. Certain embodiments of the present invention will now be discussed by way of discussing examples of specific confidentiality mechanisms. However, it should be understood that these illustrative examples are not meant to limit the scope of the invention in any way.

Wireless network traffic can get fragmented in several ways. In an IEEE 802.11 environment, the complete set of data communicated between to entities on the network is known as a MAC service data unit (MSDU), while an individual fragment is known as a MAC payload data unit (MPDU). Depending on the security mechanism, some of the confidentiality information is computed on a MSDU basis, while rest is computed over MPDU basis.

Wired fragmentation can occur because of the integration between wired and wireless networks. To integrate wired and wireless traffic, the wireless traffic is tunneled through wired medium to a wireless local area network (WLAN) switch. As this is still an evolving standard, the tunneling mechanism is not yet standardized. The path maximum transmission unit (MTU) for the wired medium may be smaller than for the wireless medium. Because of this MTU mismatch, the tunneled wireless packets can frequently be fragmented when transmitted over the wired medium. In such cases, if the WLAN switch handles security of the packets, it must be able to handle security for packets split across multiple fragments.

According to certain embodiments of the present invention, wireless traffic can be secured in a wireless equivalent privacy (WEP) environment. For encryption, WEP uses the RC4 algorithm, which is a stream based cipher. For packet authentication, the CRC32 algorithm is used as ICV. CRC32 is calculated over the clear data and appended at the end of the packet. The calculated ICV is also encrypted. For WEP, if MSDU is 802.11 fragmented, then the security information is contained in each MPDU, i.e., each fragment is individually encrypted and authenticated. In the case where the packet gets tunneled and fragmented, then the confidentiality information can be split across fragments. As RC4 encrypts data on a byte by byte basis, and CRC32 calculates the ICV incrementally on a per byte basis, embodiments of the present invention can be used. While securing fragments, CRC32 is computed for each of the fragments. For the last fragment, 4 bytes of computed ICV is appended and encrypted. For packet validation, the reverse process is applied. Here the data is first decrypted and then CRC32 is incrementally calculated over the decrypted data. For computing CRC32 across fragments, the intermediate state is stored and used as the initial state while computing the CRC32 for the next fragmnent.

According to certain embodiments of the present invention, wireless traffic can be secured in a temporal key integrity protocol (TKIP) environment. The confidentiality information for TKIP is similar to that of WEP. It uses RC4 for packet encryption, but for packet authentication CRC32 in conjunction with Michael algorithm is used. As in WEP, the encryption and CRC32 computation is done on a per MPDU basis; but Michael computation is done on a per MSDU basis, i.e., across fragments. Michael computation is also done on clear text and it results in 8 bytes of authentication data which is appended after the data bytes. Michael is a block based hash function taking 4 bytes of clear text at a time. For packet authentication, let us assume the MPDU size of the 1^{st} packet is 4×x+y, where y can be 1, 2 or 3. Now the Michael is computed as usual for 1^{st}4×x bytes. The remaining y bytes and the intermediate Michael state Mi are stored in temporary variables. These y bytes are placed before the data in the next packet and the Michael computation is restarted with initial state as Mi. This process is repeated for the subsequent fragments. At the time of packet validation, this is again repeated. In 802.11 fragmentations, the MSDU length is not provided by the header. As the Michael can get split across fragments, the last 7 bytes should not be taken for Michael computation. These 3 bytes combined with the saved bytes should be placed before the data of the next fragment and Michael computation should be performed. In case of fragmentation due to tunneling, embodiments of the present invention can be used in a similar way as described for WEP.

According to certain embodiments of the present invention, wireless traffic can be secured in an Advanced Encryption Standard—Counter mode CBC-MAC protocol (AES-CCMP) environment. AES-CCMP uses the AES algorithm in counter (CTR) mode for encryption and AES-Cipher Block Chaining-Message Authentication Code (CBC-MAC) for data authentication. In the case of tunneled wireless packets, the security information can get split across fragments. As AES-CTR encrypts packets on a per byte basis and AES-CBC MAC is a block based cipher with block size of 16, embodiments of the present invention can be used. The only caveat here is, AES-CBC-MAC needs the encrypted packet length while calculating the initial state. Hence the tunnel header should have the information related to payload length for the tunneled 802.11 packet.

According to certain embodiments of the present invention, wired traffic can be secured in a Internet protocol security (IPSec) environment. IPSec provides the flexibility of choosing from a set of well defined encryption and authentication mechanism. IPSec in ESP mode places the authentication information at the end of the packet. For authentication any of the standardized hash based functions like SHA1, MD5 and their HMAC versions or block cipher based hash functions like AES-CBC MAC, AES-XCBC, AES-OMAC and AES-CMAC can be used. In cases where an encryption algorithm like AES-CTR is chosen, which encrypts traffic on a byte by byte basis, then embodiments of the present invention can be used to secure any fragmented traffic. If an encryption algorithm encrypts data in blocks, like AES-CBC, DES-CBC or 3DES-CBC, then embodiments of the present invention can be used with the restriction that the data in fragments needing encryption should be in multiples of block sizes.

With certain embodiments of the present invention, there is no need to reassemble packets before proceeding with computation of security information. Further, certain embodiments of the present invention can be used to secure large packets (i.e., larger packets more frequently end up fragmented). Additionally, certain embodiments of the present invention can provide security at wire speed for fragmented traffic.

Although the present invention has been particularly described with reference to embodiments thereof, it should be readily apparent to those of ordinary skill in the art that various changes, modifications, substitutes and deletions are intended within the form and details thereof, without departing from the spirit and scope of the invention. Specifically, embodiments of the present invention can be used in conjunction with any confidentiality mechanism to which the above mentioned rules for incremental encryption and incremental MAC computation can be applied. Accordingly, it will be appreciated that in numerous instances some features of the invention will be employed without a corresponding use of other features. Further, those skilled in the art will understand that variations can be made in the number and arrangement of inventive elements illustrated and described in the above figures. It is intended that the scope of the appended claims include such changes and modifications.

What is claimed is:

1. A method for processing fragmented packet data, comprising the steps of:
encrypting the fragmented packet data;
computing a message authentication code (MAC) for the fragmented packet data;
decrypting the encrypted fragmented packet data; and
validating the MAC for the fragmented packet data,
wherein each of the preceding steps is performed without reassembling the fragmented packet data.

2. The method of claim 1, wherein the step of encrypting includes the steps of:
defining a plurality of plaintext fragments;
encrypting a first plaintext fragment of the plurality of plaintext fragments using an initial encryption state variable and keying material resulting in a first ciphertext fragment;
updating the initial encryption state variable to a first encryption state variable;
encrypting a second plaintext fragment of the plurality of plaintext fragments using the first encryption state variable and the keying material resulting in a second ciphertext fragment; and
updating the first encryption state variable to a second encryption state variable.

3. The method of claim 2, wherein the step of encrypting the second plaintext fragment includes first combining a last plaintext fragment of the plurality of plaintext fragments with a set of padding bytes resulting in the second plaintext fragment of a desired block size.

4. The method of claim 1, wherein the step of computing the MAC includes the steps of:
defining a plurality of packet fragments, wherein each packet fragment has a block size and a set of remainder bytes;
computing a first hash state value for a first block size of a first packet fragment of the plurality of packet fragments using an initial hash state value;
combining a first set of remainder bytes of the first packet fragment to a second packet fragment of the plurality of packet fragments resulting in a combined packet fragment of a size equal to the block size;
computing a second hash state value for the combined packet fragment using the first hash value; and
identifying the MAC using the second hash state value.

5. The method of claim 4, wherein the steps of computing the first and second hash state values use keying material.

6. The method of claim 1, wherein the step of computing the MAC includes the steps of:
defining a plurality of packet fragments, wherein each packet fragment has a block size and a set of remainder bytes;
computing a first hash state value for a first block size of a first packet fragment of the plurality of packet fragments using an initial hash state value;
combining a first set of remainder bytes of the first packet fragment to a set of padding bytes resulting in a combined packet fragment of a size equal to the block size;
computing a second hash state value for the combined packet fragment using the first hash value; and
identifying the MAC using the second hash state value.

7. The method of claim 6, wherein the steps of computing the first and second hash state values use keying material.

8. The method of claim 1, wherein the step of decrypting includes the steps of:
defining a plurality of ciphertext fragments;
decrypting a first ciphertext fragment of the plurality of ciphertext fragments using an initial decryption state variable and keying material resulting in a first plaintext fragment;
updating the initial decryption state variable to a first decryption state variable;
decrypting a second ciphertext fragment of the plurality of ciphertext fragments using the first decryption state variable and the keying material resulting in a second plaintext fragment; and
updating the first decryption state variable to a second decryption state variable.

9. The method of claim 8, wherein the step of decrypting the second ciphertext fragment includes first combining a last ciphertext fragment of the plurality of ciphertext fragments with a set of padding bytes resulting in the second ciphertext fragment of a desired block size.

10. The method of claim 1, wherein the step of validating the MAC includes the steps of:
re-computing the MAC for the fragmented packet data; and
authenticating the MAC for the fragmented packet data.

11. The method of claim 10, wherein the step of re-computing the MAC includes the steps of:
defining a plurality of packet fragments, wherein each packet fragment has a block size and a set of remainder bytes;
computing a first hash state value for a first block size of a first packet fragment of the plurality of packet fragments using an initial hash state value;
combining a first set of remainder bytes of the first packet fragment to a second packet fragment of the plurality of packet fragments resulting in a combined packet fragment of a size equal to the block size;
computing a second hash state value for the combined packet fragment using the first hash value; and
identifying the MAC using the second hash state value.

12. The method of claim 11, wherein the steps of computing the first and second hash state values use keying material.

13. The method of claim 10, wherein the step of re-computing the MAC includes the steps of:
defining a plurality of packet fragments, wherein each packet fragment has a block size and a set of remainder bytes;
computing a first hash state value for a first block size of a first packet fragment of the plurality of packet fragments using an initial hash state value;
combining a first set of remainder bytes of the first packet fragment to a set of padding bytes resulting in a combined packet fragment of a size equal to the block size;
computing a second hash state value for the combined packet fragment using the first hash value; and
identifying the MAC using the second hash state value.

14. The method of claim 13, wherein the steps of computing the first and second hash state values use keying material.

15. A method for processing fragmented packet data, comprising the steps of:
defining a plurality of plaintext fragments;
encrypting a first plaintext fragment of the plurality of plaintext fragments using an initial encryption state variable and keying material resulting in a first ciphertext fragment;
updating the initial encryption state variable to a first encryption state variable;
encrypting a second plaintext fragment of the plurality of plaintext fragments using the first encryption state variable and the keying material resulting in a second ciphertext fragment; and
updating the first encryption state variable to a second encryption state variable.

16. A system that implements the method of claim 15.

17. A method for computing a message authentication code (MAC) for fragmented packet data, comprising the steps of:
defining a plurality of packet fragments, wherein each packet fragment has a block size of bytes and a set of remainder bytes;
computing a first hash state value for a first block size of bytes of a first packet fragment of the plurality of packet fragments using an initial hash state value;
storing the first hash value and a first set of remainder bytes of the first packet fragment;
combining the first set of remainder bytes to a second packet fragment of the plurality of packet fragments resulting in a combined packet fragment;
computing a second hash state value for the combined packet fragment using the first hash value; and
identifying a message authentication code using the second hash state value.

18. A system that implements the method of claim 16.

19. A method for decrypting fragmented packet data, comprising the steps of:
defining a plurality of ciphertext fragments;
decrypting a first ciphertext fragment of the plurality of ciphertext fragments using an initial decryption state variable and keying material resulting in a first plaintext fragment;
updating the initial decryption state variable to a first decryption state variable;
decrypting a second ciphertext fragment of the plurality of ciphertext fragments using the first decryption state variable and the keying material resulting in a second plaintext fragment; and
updating the first decryption state variable to a second decryption state variable.

20. A system that implements the method of claim 17.

21. A method for processing fragmented packet data, wherein confidentiality information straddles across fragments, comprising the steps of:
encrypting the fragmented packet data, wherein encrypting the fragmented packed data includes the steps of:
defining a plurality of plaintext fragments; and
encrypting the plurality of plaintext fragments using an associated plurality of encryption state variables and encryption keying material resulting in a corresponding plurality of ciphertext fragment; and
decrypting the encrypted fragmented packet data, wherein decrypting the encrypted fragmented packet data includes the steps of:
defining a plurality of ciphertext fragments; and
decrypting the plurality of ciphertext fragments using an associated plurality of decryption state variables and decryption keying material resulting in a corresponding plurality of plaintext fragments.

22. A method for processing packet data on a communications network, wherein confidentiality information straddles across fragments, comprising the steps of:
encrypting the fragmented packet data, wherein encrypting the fragmented packed data includes the steps of:
defining a plurality of plaintext fragments; and
encrypting the plurality of plaintext fragments using an associated plurality of encryption state variables and encryption keying material resulting in a corresponding plurality of ciphertext fragment; and
computing a message authentication code (MAC) for the fragmented packet data, wherein computing the MAC includes the steps of:
defining a plurality of packet fragments, wherein each packet fragment has a block size and a set of remainder bytes;
computing a plurality of first hash state values for each first block size of each first packet fragment of the plurality of packet fragments using an associated plurality of hash state value;
identifying the MAC using a last hash state value.

23. A method for processing fragmented packet data, wherein confidentiality information straddles across fragments, comprising the steps of:
decrypting the encrypted fragmented packet data, wherein decrypting the encrypted fragmented packet data includes the steps of:
defining a plurality of ciphertext fragments; and
decrypting the plurality of ciphertext fragments using an associated plurality of decryption state variables and decryption keying material resulting in a corresponding plurality of plaintext fragments
validating the MAC for the fragmented packet data, wherein validating the MAC includes the steps of:
defining a plurality of packet fragments, wherein each packet fragment has a block size and a set of remainder bytes;
computing a plurality of first hash state values for each first block size of each first packet fragment of the plurality of packet fragments using an associated plurality of hash state value;
identifying the MAC using a last hash state value; and
authenticating the MAC for the fragmented packet data.
